(19) United States
(12) Patent Application Publication
(10) Pub. No.: US 2017/0005613 A1
(43) Pub. Date: Jan. 5, 2017

(54) SOLAR PHOTOVOLTAIC COMPONENT TRACKING APPARATUS AND INSTALLATION METHOD THEREFOR

(71) Applicant: VERSOLSOLAR HANGZHOU CO., LTD.

(72) Inventors: Xinke YANG, Hangzhou, Zhejiang (CN); Jianjing ZHU, Hangzhou, Zhejiang (CN); Hang ZHENG, Hangzhou, Zhejiang (CN); Fengjun DING, Hangzhou, Zhejiang (CN); Xinying XUE, Hangzhou, Zhejiang (CN); Lvwen HUANG, Hangzhou, Zhejiang (CN); Yunyun CHEN, Hangzhou, Zhejiang (CN); Sichun SUN, Hangzhou, Zhejiang (CN); Minjie WANG, Hangzhou, Zhejiang (CN)

(21) Appl. No.: 15/106,687

(22) PCT Filed: Mar. 25, 2014
(86) PCT No.: PCT/CN2014/073991

§ 371 Date: Jun. 20, 2016

(30) Foreign Application Priority Data
Dec. 26, 2013 (CN) 201310728619.X

(51) Int. Cl. H02S 20/32; H02S 30/10

(52) U.S. Cl. CPC H02S 20/32; H02S 30/10; F24J 2002/5482

(57) ABSTRACT

The present invention relates to a photovoltaic tracker, and in particular to a solar photovoltaic component tracking apparatus and an installation method therefor. The apparatus comprises upright posts; a main shaft is arranged between two adjacent upright posts; a photovoltaic component is arranged on the main shaft; two adjacent main shafts are connected via a connecting shaft; the connecting shaft is fixed on the upright post; the upper end face of the upright post is an upright post installation face; a through-hole is arranged on the upper portion of the upright post; and the connecting shaft is installed in the through-hole via a bearing structure. The through-hole is arranged on the upright post, and the connecting shaft is installed in the through-hole via the bearing structure. Pre-installation is firstly performed, and then the whole upright post combination is hammered integrally via a pile hammer. The present invention provides a solar photovoltaic component tracking apparatus and an installation method therefor, which is easy to install, has a simple structure and can reduce the difficulty and requirements of field installation and shorten the period and cost of installation. The technical problem existing in the prior art that a photovoltaic component tracker has lots of members, a long installation period, high difficulty in field installation and lots of field installation requirements is solved.

### TECHNICAL FIELD

The present invention relates to a photovoltaic tracker, and in particular to a tracker for solar photovoltaic component and the installation method for the tracker.

### BACKGROUND

The development of new energy and renewable clean energy is a common task that whole world is faced with. In the field of new energy, photovoltaic power generation attracts tremendous attention. However, due to the high cost, it hasn't got a full access to the market. Photovoltaic power generation has broad market prospects, however, the utilization of solar energy is inefficient and facing the problems of high construction cost and low return on investment. Currently. the installation methods for solar photovoltaic component mainly include two modes: fixed mode and automatic tracking mode. By using automatic tracking mode, the generating capacity may improve by about 20% than that of the fixed mode, therefore, it has broad market prospects. However, some of the tracking apparatuses for photovoltaic component according to current research commonly comprise defects such as a complex structure, long field installation period and high requirements of the quality for installation personnels. These defects seriously restrict the promotion of photovoltaic tracking apparatus, hence, further improvement and simplification are required. In all disclosed documents for the present, Chinese patent: “Solar Energy Tracking Structure (CN202854613U)”comprises several solar photovoltaic cell panels and support frames for the solar photovoltaic cell panels, two ends and the central section of each of the solar photovoltaic cell panel are connected with another solar photovoltaic cell panel by using a support fame for solar photovoltaic cell panel. The lower parts of several support fames for solar photovoltaic cell panels are connected with the support mechanism. Tracking mechanism which moves in accordance with the solar position of heavenly circuit is arranged on one side of the support mechanism. Therefore, the solar light-emitting photovoltaic panels on tracking mechanism may always keep a best beam angle with the sun, improving the generating efficiency of the photovoltaic panels. But all solar component devices are somewhat large in size, it is very inconvenient to lift them up for installation.

### DISCLOSURE OF THE INVENTION

The present invention provides a solar photovoltaic component tracking apparatus and an installation method therefor, which is easy to install, has a simple structure and can reduce the difficulty and requirements of field installation and shorten the period and cost of installation. The technical problem existing in the prior art that a photovoltaic component tracker has lots of members, a long installation period, high difficulty in field installation and lots of field installation requirements is solved.

The technical problems mentioned above of the present invention are solved by the technical solutions below: a tracking apparatus for solar photovoltaic component, comprising upright posts; a main shaft is arranged between two adjacent upright posts; a photovoltaic component is arranged on the main shaft; two adjacent main shafts are connected via a connecting shaft; the connecting shaft is fixed on the upright post; the upper end face of the upright post is an upright post installation face; a through-hole is arranged on the upper portion of the upright post; and the connecting shaft is installed in the through-hole via a bearing structure; the cross section of the connecting shaft is smaller than that of the main shaft, and the connecting shaft is connected with the main shaft via the structure of shaft connection. The integral system consists of structures such as several photovoltaic components, upright post combinations and main shaft combinations. In former installation, the upright posts are usually hammered by pile hammer firstly and then installed with structures such as bearings and main shafts. As the upright post has a certain hight, the installation of upright posts followed by the installation of bearings and main shafts is strenuous for lifting and time-consuming for installation. In the present invention, through-hole is arranged on the upper portion of the upright post, and the connecting shaft is installed in the through-hole via the bearing structure. Pre-installation is firstly performed, and then the whole upright post combination is hammered integrally via a pile hammer. As the through-hole is arranged on the upper portion of the upright post, the through-hole is vertical with the length direction of the upright post without any changes to the thrust face for the installation of the upright post, thus saving time and effort during the installation. The cross section of the main shaft is somewhat large, therefore provides convenience for the installation and fixation of the photovoltaic component. The cross section of the main shaft is similar with the width of the upright post and the cross section of the connecting shaft is smaller than that of the main shaft, providing convenience for installing the connecting shaft into the through-hole on the upright post.

As preferred, the bearing structure comprises a bearing pedestal fixed on the upright post; a bearing is arranged in the bearing pedestal; a positioning structure is arranged between the bearing pedestal and the bearing, and a mounting is arranged between the bearing structure and the connecting shaft

The bearing pedestal is welded onto the upright post. It has a simple structure and no additional installation members are required. The relative positions of the connecting shaft and the bearing structure are fixed by the mounting.

Once penetrated the main shaft into the bearing structure, it is possible to rotate the main shaft freely in the bearing, then fix the main shaft with the bearing structure in axial direction relatively via the mounting. Then transport the whole pre-installed upright post combination to the field and hammer the upright posts into the ground with special piling equipment, thus, the field installation work of the upright post combination is completed. The pre-installation greatly improves the speed for field installation, therefore saving the installation time and improving the work efficiency.

As preferred, the bearing refers to a detachable bearing; the bearing comprises two bearing bodies which sharing the same structure; a flange is arranged on the end part of the bearing body; the two bearing bodies are respectively inserted through the two ends of the bearing pedestal into the bearing pedestal; the bearing body is in the shape of semicircle and the bearing pedestal is cylindrical; the flange of the bearing body abuts on the outer edge of the bearing pedestal and the length of the bearing body is no more than the length of the bearing pedestal. Flange is arranged on the bearing body to allow the two ends of the bearing body to insert into the bearing pedestal, the flanges of the two bearing bodies abut on the outer edge of the bearing pedestal to form an integral bearing; the length of the bearing body and that of the bearing pedestal are roughly equivalent, that brings a good match-oriented and provides a complete support for the main shaft. Then fix the bearing body together with the bearing pedestal by using the positioning structure to form a bearing structure; the detachable bearing is easy to install, adjust and replace.

As preferred, the positioning structure comprises two positioning slots notched respectively on two end faces of the bearing pedestal; the positioning slots locate on two ends of the same diameter; a positioning protuberance is arranged on the flange of the bearing body; the positioning protuberance locates on the middle part of the curved flange; the mounting refers to a hoop. The bearing bodies share the same shape, it is possible to install with any one of the two ends; a cylinder with the same shape of the bearing pedestal is formed as the result of engaging two bearing bodies; one bearing body is inserted from the left side of the bearing pedestal by using the outer edge of the bearing pedestal of the upside semicircle and the flange of the bearing body for positioning; the other bearing body is inserted from the right side of the bearing pedestal by using the outer edge of the bearing pedestal of the downside semicircle and the flange of the bearing body for positioning; the flange and the outer edge are positioning for the axial direction of the bearing body and the bearing pedestal. Concurrently, positioning the bearing pedestal and the bearing body on the peripheral direction by using the matching of the positioning protuberance on the flange and the positioning slots on the bearing pedestal 2 positioning slots are arranged on the bearing pedestal to provide convenience for the installation of bearing body; both upside semicircle and downside semicircle are appropriate for being installed on the left side, thus brings improved convenience and efficiency for the installation.

The hoop owns a simple structure and is easy for installing with an outstanding fixation degree. As preferred, the cross section of the upright post is in the shape of letter “H”, the upright post comprises upright post edge plate and upright wing plate on both sides of the edge plate; a through-hole is arranged on the upright post edge plate, and the bearing pedestal is plugged in the through-hole; the outer edge of the bearing pedestal is welded on the upright post edge plate, reinforcing rib plates are arranged on the lower part of the bearing pedestal; the there are two pieces of the reinforcing rib plates, the reinforcing rib plates are located on both sides of the upright post edge plate; the two ends of the reinforcing rib plates are welded on the upright wing plate, and the inner circular surface of the rib plate is welded to the outer circular surface of the bearing pedestal. The bearing pedestal is welded on the upright post edge plate in the middle of the upright post. In order to enhance the stability after welding, two pieces of the reinforcing rib plates are added on the lower part of the bearing pedestal. It is equivalent to increase the wielding thickness for the downside semicircle of the bearing pedestal on the upright post edge plate, therefore the supporting surface becomes thicker to improve the supporting strength.

As preferred, the cross section of the connecting shaft is in the shape of the racetrack; the main shaft refers to a square shaft, the width of the main shaft is greater than the width of the connecting shaft; a main shaft connector is arranged on the end part of the main shaft; the main shaft connector comprises positioning structure and fixation structure; a fixation structure corresponding to the main shaft connector is arranged on the connecting shaft. The processing of the racetrack shape is to form two parallel planes by grinding on the basis of the round shape; the two parallel planes are convenient for fixing to the main shaft; the two arc surfaces are convenient for rotating in the bearing, and the circular connecting shaft is convenient for being installed in the upright post with its small cross section; the cross section of the connecting shaft is smaller than the upright post, it is possible to install the main shaft onto the upright post firstly and then install the pre-installed upright post structure in the field. The structure of the main shaft stays the same, the main shaft connects with the connecting shaft via the main shaft connector on the end part of the main shaft; the main shaft and the connecting shaft are positioned with the positioning structure of the main shaft connector, and then connected with the fixation structure.

As preferred, the main shaft connector comprises a main shaft cover. The main shaft cover is welded to the end part of the main shaft; the fixation structure comprises two parallel fixation plates; the two fixation plates are welded to the main shaft cover and the distance between them is no less than the diameter of the connecting shaft; the fixation structure refers to a curved apron plate, the radian of the apron plate is the same with the radian of the connecting shaft; the apron plate locates between two parallel fixation plates which making up the fixation structure, the two ends of the apron plate are welded to the fixation plates on the two ends respectively; fixing holes are arranged on both of the fixation plate and the apron plate, the fixing hole refers to a slotted hole; through-holes corresponding to the fixing holes are arranged on the two parallel side surfaces and the upside and downside curved surfaces of the connecting shaft. The fixing holes are arranged on the top and side surfaces of the main shaft and the connecting shaft respectively; the fixation is formed with two directions, thus the fixation degree is good and the bearable torque during the rotating is large to ensure the reliability of the rotating. Moreover, the fixing holes are shaped into slotted holes to provide convenience for adjusting the fixation position, improving the convenience for the installation. The shape of the curved apron plate matches with the radian of the connecting shaft; as the volume of the main shaft is larger than the rotating shaft, in order to provide convenience for positioning of them, when installing the main shaft, the main shaft is lifted and top-down placed firstly, the apron plate is lapped on the rotating shaft to determine the position for both of them, then they are fixed and connected with the help of the fixation structure.

As preferred, the photovoltaic component is installed in the photovoltaic component framework; the photovoltaic component framework is fixed on the beam via a block; the beam is fixed on the main shaft and an open slot is arranged on the top of the beam; a base plate is arranged on the top of the beam and a grounding spacer is arranged on the base plate; a clamp device is arranged on the bottom of the base plate, the block fixes the photovoltaic component framework onto the grounding spacer via the clamp device. Install the grounding spacer on the base plate; once the photovoltaic component framework is pressed on the grounding spacer via the block, the grounding spacer will pierce the thin film on the photovoltaic component framework, thus realizing the grounding for the photovoltaic component framework without external connection with any additional grounding components. The block is fixed on the clamp device on the bottom of the base plate via bolt; the block compresses the photovoltaic component framework on the grounding spacer to fix the grounding spacer.

As preferred, a through-hole is arranged in the center of the base plate, a pressing part is arranged in the through-hole; the pressing part comprises a pressing plate and hooks arranged on the bottom of the pressing plate; the area of the pressing plate is larger than the area of the through-hole; the pressing plate is pressed on the grounding spacer; there are two hooks arranged in parallel, the body of the hook bends inward to form a lock slot; a clamp device is arranged in the lock slot; the clamp device refers to a strip nut, a threaded hole is arranged in the center of the strip nut; the distance between the strip nut and the lower surface of the base plate is the same with the thickness of the slot edge of the open slot.

The pressing part allows the pressing plate to press the grounding spacer onto the base plate; through-hole is also arranged in the center of the grounding spacer, the pressing plate presses on the grounding spacer and the hook passes through the through-hole; the two hook bodies bends inward to form a elastic lock slot, the strip nut can be fixed in the lock slot to connect with the bolt penetrated in the block, therefore to fix the block.

At the same time, the strip nut can also play a role of fixing the pressing part onto the base plate. The direction of the strip nut is the same with the length direction of the base plate; the narrow surface of the strip nut is inserted into the open slot firstly and once the base plate moved in place, it is rotated by 90°; the length of the strip nut is just equal to the width of the inner edge of the cross section of the beam, thus getting the strip nut stuck in the beam and fixed the base plate on the beam.

The installation method for a solar photovoltaic component tracking apparatus, First step, install the upright post combination: Install the connecting shaft into the through-hole via the bearing and the bearing pedestal, the upper end face of the upright post can also act as the thrust face for the piling equipment. Then hammer the upright post with bearing structure and connecting shaft into the ground. After that, connect the main shafts together with the connecting shaft;

Second step, install the main shaft combination: Then install the beam onto the connecting shaft and install the photovoltaic component into the photovoltaic component framework. Fix the photovoltaic component framework on the beam via the pressing plate, the grounding spacer on the beam will pierce the thin film on the photovoltaic component framework to realize grounding; Once the photovoltaic component is installed on the beam, use the block to press on it and tighten the bolt;

Third step, assemble and install the main shaft combination with the finished upright post combination by lifting equipment. The structures of the upright post combination and the main shaft combination are in accordance with the structures of the tracking apparatus mentioned above. Firstly, pre-install the connecting shaft to the upright post via the bearing structure, concurrently, pre-install the photovoltaic component framework onto the beam. Then hammer the upright post into the ground via a pile hammer and install the main shaft to the upright post. In this way, the lifting equipment is just required to lift up the main shaft combination. Install the main shaft combination with the photovoltaic component framework onto the main shaft. In this way, all these numerous parts which are hard for carrying and installing can be installed on a workbench in a pipeline mode now, thus reducing the time and difficulty for field installation.

Therefore, the solar photovoltaic component tracking system and the installation method therefor according to the present invention comprise the following advantages:

Install the bearing and the connecting shaft onto the upright post after trepanning on the upright post to maintain the original installation surface of the upright post, allowing the pile hammer to hammer them in a whole and reducing the work difficulty; Getting the parts such as main shaft, beam and component pre-installed in the field, therefore all these numerous parts which are hard for carrying and installing can be installed on a workbench in a pipeline mode now, thus reducing the time and difficulty for field installation.

### BRIEF DESCRIPTION OF THE DRAWINGS

FIG. 1 is a schematic diagram for a solar photovoltaic component tracking apparatus.

FIG. 2 is an enlarged view of A area in FIG. 1.

FIG. 3 is an explosive view for installation of the upright post combination in FIG. 1.

FIG. 4 is a schematic diagram for the main shaft in FIG. 1.

FIG. 5 is a schematic diagram for the main shaft combination in FIG. 1.

FIG. 6 is an enlarged view of B area in FIG. 5.

FIG. 7 is a schematic diagram for FIG. 6 excluding the photovoltaic component and the block.

FIG. 8 is a schematic diagram for the base plate in FIG. 7.

FIG. 9 is a schematic diagram for the base plate in FIG. 7 in another direction.

FIG. 10 shows the tracking system formed by the solar photovoltaic component tracking apparatus.

### MOST PREFERRED METHOD FOR REALIZING THE PRESENT INVENTION

The technical solutions of the present invention will be further described below through embodiments and drawings.

Embodiment 1:

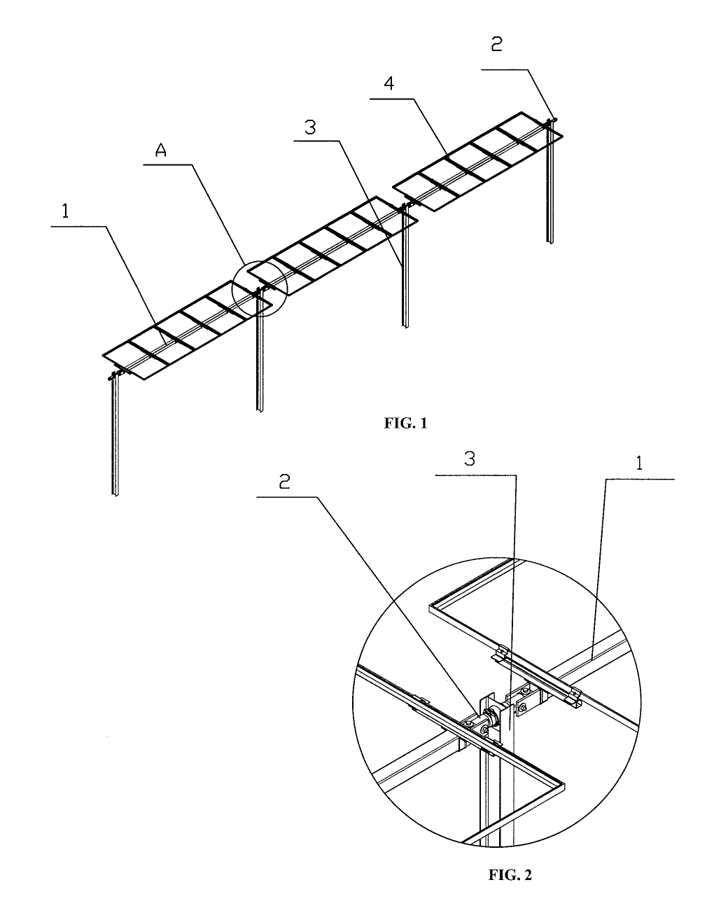

A solar photovoltaic component tracking apparatus as shown in FIGS. 1 and 2, comprising upright post combination and main shaft combination. Wherein, the upright post combination comprises the upright post 3 with the cross section in shape “H”, bearing structure, and the connecting shaft 2 and so on;

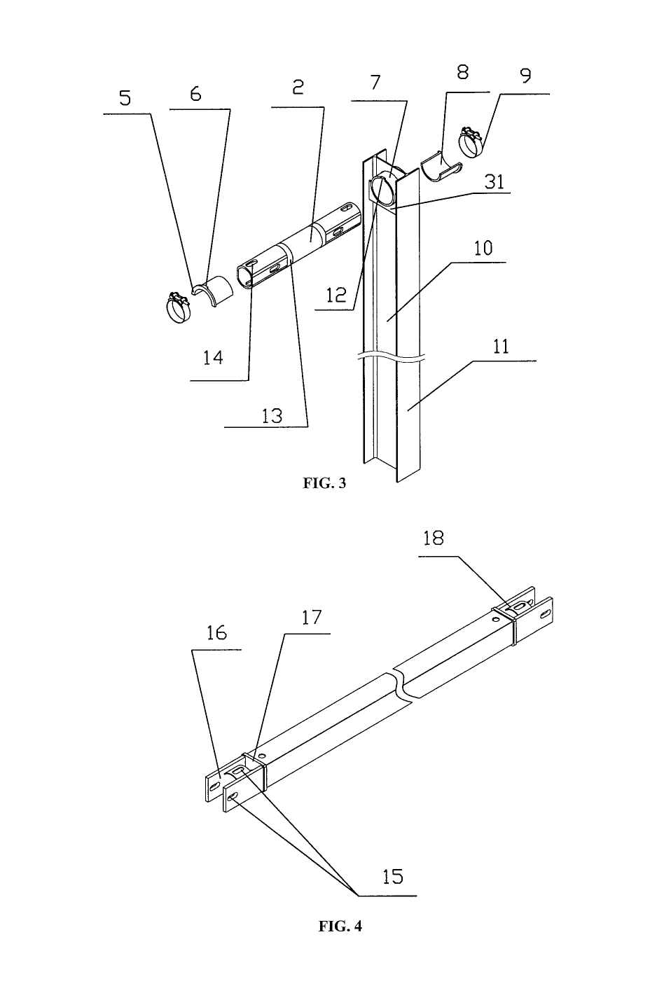

The main shaft combination comprises main shaft 1, beam 20, photovoltaic component 4 and so on. Main shaft 1 locates between two upright posts 3, photovoltaic component 4 is fixed on the main shaft 1. Two adjacent main shafts 1 are connected via a connecting shaft 2, the connecting shaft 2 is fixed on the upright post 3. As shown in FIG. 3, the upright post 3 comprises upright post edge plate 10 and the parallel upright wing plates 11 on both sides of the upright post edge plate 10; a circular through-hole is arranged on the center of the upper end of the upright post edge plate 10, a cylindrical bearing pedestal 7 is welded in the through-hole; the outer edge of the bearing pedestal 7 is welded on the upright post edge plate 10, two reinforcing rib plates 31 are arranged on the lower part of the bearing pedestal 7; the reinforcing rib plates 31 are in the shape of rectangle, arc surfaces are arrange in the center of the reinforcing rib plates 31; the arc surface is in the shape of semicircle, and the radius of the arc surface is the same with the bearing pedestal; at the joint part for outer circular surface and bearing pedestal 7, the length of the reinforcing rib plates 31 is the same with the upright post edge plate 10; the two ends of the reinforcing rib plates 31 are welded to the upright wing plates 11. The two reinforcing rib plates 31 are located on both sides of the upright post edge plate 10, therefore increasing the thickness of the supporting surface for the downside semicircle of the bearing pedestal 7 and improving the supporting strength. Positioning slots 12 are notched on both ends of the bearing pedestal 7; two positioning slots 12 on the same end are located in the same diameter; the positioning slots 12 on the upper side of the two ends are located in the same generatrix. A bearing is plugged in the bearing pedestal 7; the bearing consists of two bearing bodies in the same shape; the bearing body 8 is in the in the shape of semicircle, the radius of its outer circular surface is the same with the bearing pedestal, and the radius of its inner circular surface is the same with the radius of the main shaft plugged in the bearing. The bearing body 8 is a plastic bearing, a flange 5 in the shape of semicircular ring is integrally shaped on one end of the bearing body 8; a positioning protuberance 6 matching with the positioning slot is shaped in the middle part of the semicircular flange 5. Two bearing bodies 8 are spliced to form an integral cylindrical bearing; the two bearing bodies 8 are inserted into the bearing pedestal 7 through the two ends of the bearing pedestal 7; one bearing body 8 is inserted into the bearing pedestal 7 from the left end, the flange of the bearing body 8 abuts on the upside semicircle of the bearing pedestal 7; the positioning protuberance 6 on the bearing body 8 matches with the positioning slot 12 of the upside semicircle on the left side of the bearing pedestal; the other bearing body 8 is inserted into the bearing pedestal from the right end, the flange of the bearing body abuts on the downside semicircle of the bearing pedestal; the positioning protuberance of the bearing body matches with the positioning slot 12 of the downside semicircle on the right side of the bearing pedestal. Thus, positioning the bearing pedestal and the bearing. Plug the connecting shaft 2 into the bearing, the connecting shaft 2 is used for connecting two adjacent main shafts 1. Lock slot 13 is arranged on the connecting shaft 2; once plugged the connecting shaft 2 is in the bearing, install a hoop 9 in the lock slot, the hoop 9 is used for fixing and locking.

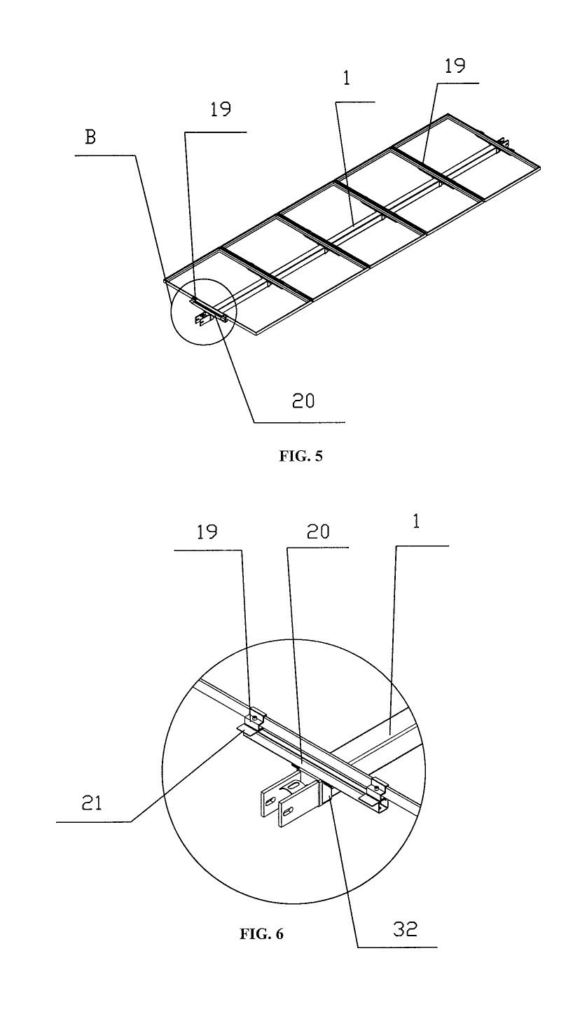

The cross section of connecting shaft 2 is in the shape of the racetrack; the main shaft 1 refers to a square shaft, that is, a square hollow steel tube; the width of the main shaft 1 is larger than the width of the connecting shaft; a main shaft connector is arranged at the end part of the main shaft as shown in FIG. 4; the main shaft connector comprises positioning structure and fixation structure; a fixation structure corresponding to the main shaft connector is arranged on the connecting shaft. The main shaft connector comprises a main shaft cover 17, the main shaft cover 17 is welded to the end part of the main shaft; the fixation structure comprises two parallel fixation plates 16; the two fixation plates 16 are welded to the main shaft cover 17; a cavity in the shape of letter “U” is formed by the two fixation plates 16 and the main shaft cover 17; the distance between the two fixation plates 16 is no less than the diameter of the connecting shaft 2 to accommodate the connecting shaft 2 thereinto; the fixation structure refers to a curved apron plate 18, the radian of the apron plate 18 is the same with the radian of the connecting shaft; the apron plate 18 locates between two parallel fixation plates 16 which making up the fixation structure, the two ends of the apron plate are welded to the fixation plates 16 on the two ends respectively; the two parallel surfaces of the connecting shaft 2 are connected with the fixation plate 16, the curved surface of the connecting shaft is connected with the apron plate 18. Fixing holes 15 are arranged on both of the fixation plate 16 and the apron plate 18; the fixing hole 15 refers to a slotted hole; the fixing hole 15 on the fixation plate 16 is located on the open end of the “U” shaped cavity and the fixing hole on the apron plate is located on the middle of the “U” shaped cavity; through-holes corresponding to the fixing holes 14 are arranged on the two parallel side surfaces and the upside and downside curved surfaces of the connecting shaft; when fixing, a cross fixation in the shape of “X” is formed via the bolt in horizontal and vertical directions, bringing a outstanding fixation degree.

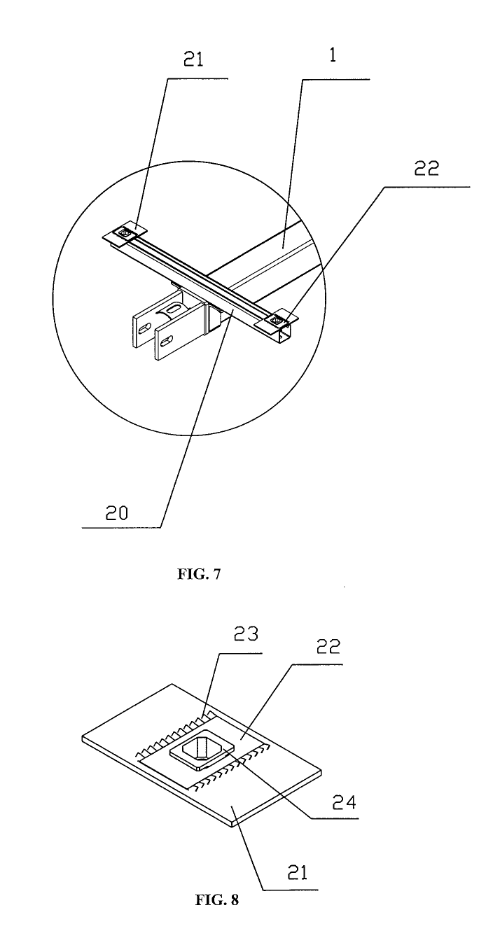

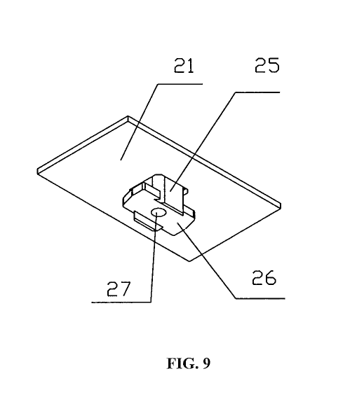

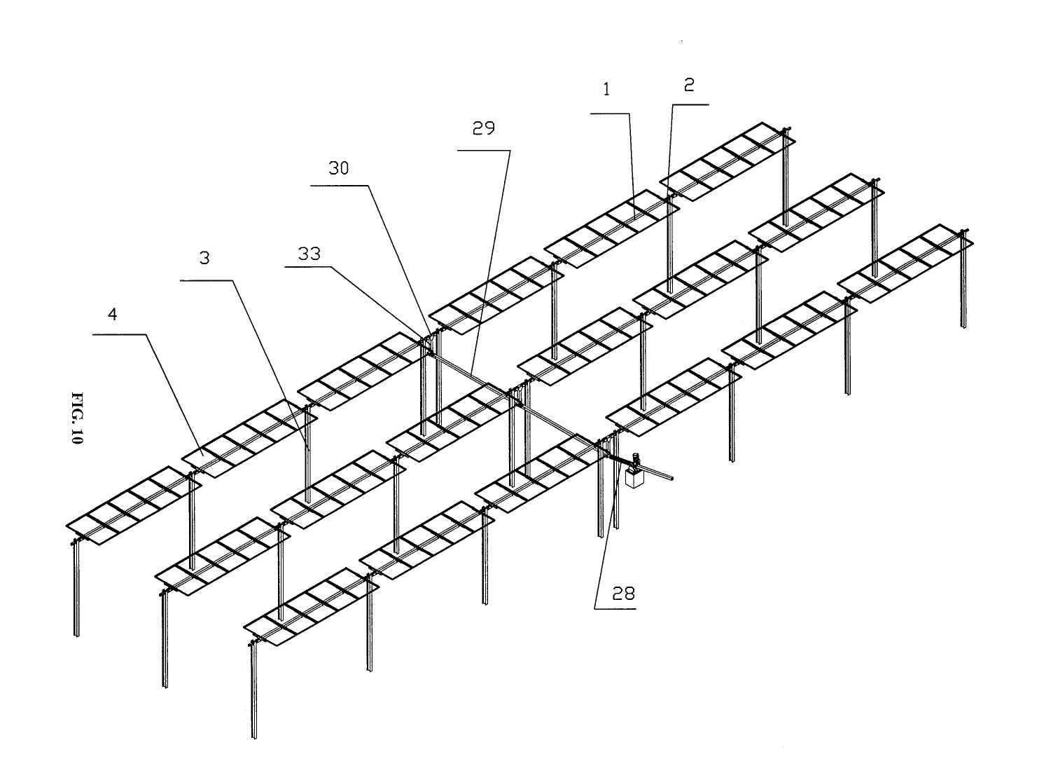

As shown in FIGS. 5, 6 and 7, the photovoltaic component is installed in the photovoltaic component framework and the photovoltaic component framework is fixed on the beam via the block 19; the block 19 on the middle of the photovoltaic component apparatus appears as the shape of “n”; it is possible to keep pressing on the photovoltaic frameworks of both sides at the same time, thus, the block 19 on the edge of the photovoltaic component apparatus will appear as the shape of stair. The beam 20 is fixed onto the main shaft 1 via the main shaft hoop 32; an open slot is arranged on the top of the beam; a base plate 21 is installed on the top of the beam and a grounding spacer 22 is installed on the base plate 21; a strip nut 26 is fixed on the bottom of the base plate 21; the beam 20 refers to a U shaped steel; the two parallel edges of the beam 20 roll inward to form a slot edge; the strip nut 26 is stuck into the open slot and then rotated by 90°; the edge of the strip nut 26 is stuck on the slot edge; then fix the base plate 21 onto beam 20. As shown in FIGS. 8 and 9, a through-hole is arranged in the center of the base plate 21; a threaded hole 27 corresponding to the through-hole in the center of the base plate is arranged on the strip nut 26; the bolt passes through pressing plate 19, grounding spacer 22 and base plate 21 successively; then it is fixed into the threaded hole of the strip nut 26. A through-hole is arranged in the center of the base plate 21, a pressing part is arranged in the through-hole; the pressing part comprises a pressing plate 24 and hooks 25 arranged on the bottom of the pressing plate 24; the pressing plate 24 and the hooks 25 are integrally shaped from plastics. The area of pressing plate 24 is larger than the area of the through-hole; the pressing plate 24 is pressed on the grounding spacer 22; there are two hooks 25, and the two hooks 25 are arranged in parallel; the body of the hook 25 bends inward to form a lock slot; a strip nut 26 is fixed in the lock slot; the distance between the strip nut 26 and the lower surface of the base plate is the same with the thickness of the slot edge of the open slot.

Two parallel rows of barbs 23 are arranged on the grounding spacer; once the photovoltaic component framework is pressed on the grounding spacer, the barbs will pierce the thin film on the photovoltaic component framework to realize grounding.

As shown in FIG. 10, once connected the upright post combination with the main shaft combination of the tracking apparatus respectively, a transmission combination is used to drive the rotation of the whole apparatus; the transmission combination comprises a swing arm 30 connected between two adjacent connecting shafts; the swing arm 30 is fixed to linkage rod 29 via swing rod 33; the end of the linkage rod 29 is connected to push rod 28; the linkage rod 29 is pushed to move via the push rod 28, thus driving the rotation of each connecting shaft; the rotation of the connecting shafts drives the main shaft to rotate and track the direction of the sun.

Embodiment 2: The installation method for a solar photovoltaic component tracking apparatus, First step, install the upright post combination: Trepan at center top of the upright post and weld the reinforcing rib plate to the part under the through-hole of the upright post, then weld the bearing pedestal; the detachable bearings are inserted into both ends of the bearing pedestal and then fixed via the positioning structure. Then plug the connecting shaft into the bearing; the connecting is fixed onto the upright post via the hoop. The upper end face of the upright post can also act as the thrust face for the piling equipment; then hammer the upright post with bearing structure and connecting shaft into the ground. after that, connect the main shafts together with the connecting shaft;

Second step, install the main shaft combination: Install the beam onto the connecting shaft by using main shaft hoop, and install the base plate on the beam. Insert the narrow surface of the strip nut into the open slot of the beam; Rotate the base plate once the position is selected; As the strip nut shares the same length and direction of the base plate, the length of the strip nut is greater than the inner width of the open slot which is smaller than the cross section of the beam; therefore, the strip nut is pressed on the slot edge of the open slot, thus fixing the base plate onto the beam; then compress the photovoltaic component framework o the grounding spacer, the barbs on the grounding spacer will pierce the thin film on the photovoltaic component framework to realize grounding. Install the photovoltaic component into the photovoltaic component framework; fix the photovoltaic component framework on the beam via the pressing plate, the grounding spacer on the beam will pierce the thin film on the photovoltaic component framework to realize grounding; Once the photovoltaic component is installed on the beam, use the block to press on it and tighten the bolt;

Third step, assemble and install the main shaft combination with the finished upright post combination by lifting equipment, the main shaft is connected with the connecting shaft via the fixation structure and positioning structure on the main shaft connector. Through-holes corresponding to the fixing holes are arranged on the two parallel side surfaces and the upside and downside curved surfaces of the connecting shaft; when fixing, a cross fixation in the shape of “X” is formed via the bolt in horizontal and vertical directions.

1. A tracking apparatus for solar photovoltaic component, comprising upright posts; a main shaft is arranged between two adjacent upright posts; a photovoltaic component is arranged on the main shaft; two adjacent main shafts are connected via a connecting shaft; the connecting shaft is fixed on the upright post; it is wherein the upper end face of the upright post is an upright post installation face; a through-hole is arranged on the upper portion of the upright post; and the connecting shaft is installed in the through-hole via a bearing structure; the cross section of the connecting shaft is smaller than that of the main shaft, and the connecting shaft is connected with the main shaft via the structure of shaft connection, and wherein photovoltaic component is installed in the photovoltaic component framework; the photovoltaic component framework is fixed on the beam via a block; the beam is fixed on the main shaft and an open slot is arranged on the top of the beam; a base plate is arranged on the top of the beam and a grounding spacer is arranged on the base plate; a clamp device is arranged on the bottom of the base plate, the block fixes the photovoltaic component framework onto the grounding spacer via the clamp device.

2. The tracking apparatus for solar photovoltaic component according to claim 1, wherein the bearing structure comprises a bearing pedestal fixed on the upright post; a bearing is arranged in the bearing pedestal; a positioning structure is arranged between the bearing pedestal and the bearing, and a mounting is arranged between the bearing structure and the connecting shaft.

3. The tracking apparatus for solar photovoltaic component according to claim 2, wherein the bearing refers to a detachable bearing; the bearing comprises two bearing bodies which sharing the same structure; a flange is arranged on the end part of the bearing body; the two bearing bodies are respectively inserted through the two ends of the bearing pedestal into the bearing pedestal; the bearing body is in the shape of semicircle and the bearing pedestal is cylindrical; the flange of the bearing body abuts on the outer edge of the bearing pedestal and the length of the bearing body is no more than the length of the bearing pedestal.

4. The tracking apparatus for solar photovoltaic component according to claim 2, wherein the positioning structure comprises two positioning slots notched respectively on two end faces of the bearing pedestal; the positioning slots locate on two ends of the same diameter; a positioning protuberance is arranged on the flange of the bearing body; the positioning protuberance locates on the middle part of the curved flange; the mounting refers to a hoop.

5. The tracking apparatus for solar photovoltaic component according to claim 1 wherein the cross section of the upright post is in the shape of letter “H”, the upright post comprises upright post edge plate and upright wing plate on both sides of the edge plate; a through-hole is arranged on the upright post edge plate, and the bearing pedestal is plugged in the through-hole; the outer edge of the bearing pedestal is welded on the upright post edge plate, reinforcing rib plates are arranged on the lower part of the bearing pedestal; the there are two pieces of the reinforcing rib plates, the reinforcing rib plates are located on both sides of the upright post edge plate; the two ends of the reinforcing rib plates are welded on the upright wing plate, and the inner circular surface of the rib plate is welded to the outer circular surface of the bearing pedestal.

6. The tracking apparatus for solar photovoltaic component according to claim 1 wherein the cross section of the connecting shaft is in the shape of the racetrack; the main shaft refers to a square shaft; the width of the main shaft is greater than the width of the connecting shaft; a main shaft connector is arranged on the end part of the main shaft; the main shaft connector comprises positioning structure and fixation structure; a fixation structure corresponding to the main shaft connector is arranged on the connecting shaft.

7. The tracking apparatus for solar photovoltaic component according to claim 6, wherein the main shaft connector comprises a main shaft cover; the main shaft cover is welded to the end part of the main shaft; the fixation structure comprises two parallel fixation plates; the two fixation plates are welded to the main shaft cover and the distance between them is no less than the diameter of the connecting shaft; the fixation structure refers to a curved apron plate, the radian of the apron plate is the same with the radian of the connecting shaft; the apron plate locates between two parallel fixation plates which making up the fixation structure, the two ends of the apron plate are welded to the fixation plates on the two ends respectively; fixing holes are arranged on both of the fixation plate and the apron plate, the fixing hole refers to a slotted hole; through-holes corresponding to the fixing holes are arranged on the two parallel side surfaces and the upside and downside curved surfaces of the connecting shaft.

8. (canceled)

9. The tracking apparatus for solar photovoltaic component according to claim 8, wherein a through-hole is arranged in the center of the base plate; a pressing part is arranged in the through-hole; the pressing part comprises a pressing plate and hooks arranged on the bottom of the pressing plate; the area of the pressing plate is larger than the area of the through-hole; the pressing plate is pressed on the grounding spacer; there are two hooks arranged in parallel, the body of the hook bends inward to form a lock slot; a clamp device is arranged in the lock slot; the clamp device refers to a strip nut, a threaded hole is arranged in the center of the strip nut; the distance between the strip nut and the lower surface of the base plate is the same with the thickness of the slot edge of the open slot.

10. A installation method for a solar photovoltaic component tracking apparatus according to claim 1, wherein first step, install the upright post combination: install the connecting shaft into the through-hole via the bearing and the bearing pedestal, the upper end face of the upright post can also act as the thrust face for the piling equipment; then hammer the upright post with bearing structure and connecting shaft into the ground; after that, connect the main shafts together with the connecting shaft; second step, install the main shaft combination: then install the beam onto the connecting shaft and install the photovoltaic component into the photovoltaic component framework; fix the photovoltaic component framework on the beam via the pressing plate, the grounding spacer on the beam will pierce the thin film on the photovoltaic component framework to realize grounding; once the photovoltaic component is installed on the beam, use the block to press on it and tighten the bolt; third step, assemble and install the main shaft combination with the finished upright post combination by lifting equipment.
